(19) United States
(12) Patent Application Publication
(10) Pub. No.: US 2013/0168109 A1
(43) Pub. Date: Jul. 4, 2013

(54) PACKAGED INERTING SYSTEM FOR FIRE PROTECTION SPRINKLER SYSTEM AND METHOD OF INERTING A FIRE PROTECTION SPRINKLER SYSTEM

(71) Applicants: Jeffrey T. Kochelek, Creve Coeur, MO (US); Adam H. Hilton, Chesterfield, MO (US); Kenneth Jones, Barto, PA (US); Thorstein Holt, Glencoe, MO (US)

(72) Inventors: Jeffrey T. Kochelek, Creve Coeur, MO (US); Adam H. Hilton, Chesterfield, MO (US); Kenneth Jones, Barto, PA (US); Thorstein Holt, Glencoe, MO (US)

(73) Assignees: HOLTEC GAS SYSTEMS, Chesterfield, MO (US); FIRE PROTECTION SYSTEMS CORROSION MANAGEMENT, INC., St. Louis, MO (US)

(21) Appl. No.: 13/823,160

(22) PCT Filed: Sep. 16, 2011
(86) PCT No.: PCT/US11/51907

§ 371 Date: Mar. 14, 2013

Related U.S. Application Data
(60) Provisional application No. 61/383,396, filed on Sep. 16, 2010.

(51) Int. Cl. A62C 35/62; A62C 35/68

(52) U.S. Cl. CPC A62C 35/62; A62C 35/68
USPC 169/17; 137/1

(57) ABSTRACT

A fire protection sprinkler system inerting apparatus and method includes selectively connecting an inert gas source and a gas vent to the fire protection sprinkler system with a valve system and controlling the valve system. The valve system is controlled to selectively connect the inert gas source with the sprinkler system to add inert gas to the sprinkler system to increase the proportion of inert gas in the gas mixture within the sprinkler system and to operate the gas vent to discharge a portion of the gas mixture from the sprinkler system.

### CROSS-REFERENCE TO RELATED APPLICATION

This application claims priority from U.S. provisional patent application Ser. No. 61/383,396, filed on Sep. 16, 2010, the disclosure of which is hereby incorporated herein by reference in its entirety.

### BACKGROUND OF THE INVENTION

The present invention is directed to a fire protection sprinkler system and, in particular, to an inerting system for providing an atmosphere within the dry portion of a dry sprinkler system that is high in inert gas and, therefore, low in oxygen.

Water in a steel iron or other low alloy ferrous pipe of a fire protection sprinkler system causes corrosion of the metal from the oxygen in the air and water. While it is known to modify the atmosphere, or gas mixture, within a sprinkler system to reduce corrosion, known systems are difficult to install and difficult to operate, thereby incurring a significant cost for the installation and maintenance of the systems. As a result, the benefits of modified atmospheres within sprinkler systems are not fully realized.

### SUMMARY OF THE INVENTION

The present invention provides an apparatus and method that is capable of changing the atmosphere of the piping in a complex fire protection sprinkler system from one in which the concentration of oxygen supports significant corrosion of the metal to one in which a non-corrosive inert gas, such as nitrogen, has replaced almost all of the oxygen. So, corrosion comes to a virtual standstill. This is accomplished by an apparatus and method that is automated thereby reducing or even eliminating maintenance technician labor and potential error. Also, it is possible to process the various parts, or zones, of a complex sprinkler system from a single location, for example, at the sprinkler system riser room or in a central source of inerting gas. This facilitates simple installation, monitoring and maintenance.

A fire protection sprinkler system inerting apparatus and method, according to an aspect of the invention, includes selectively connecting an inert gas source and a gas vent to the fire protection sprinkler system with a valve system and controlling the valve system. The valve system is controlled to selectively connect the inert gas source with the sprinkler system to add inert gas to the sprinkler system to increase the proportion of inert gas in the gas mixture within the sprinkler system and to operate the gas vent to discharge a portion of the gas mixture from the sprinkler system.

The valve system may be controlled to open the gas vent to discharge a portion of the air from the sprinkler system when the inert gas source is disconnected from the sprinkler system and to close the gas vent when the inert gas source is adding inert gas to the sprinkler system. The inerting system may be connected with the sprinkler system with a supply line or manifold. In this manner, the inert gas source supplies inert gas through the supply line to the sprinkler system and the gas vent discharges a portion of the gas mixture from the sprinkler system through the supply line. A pressure transducer may sense pressure in the supply line and provide pressure data. A control opens and closes the gas vent and connects and disconnects the inert gas source in response to the pressure data.

A float-operated valve that is adapted to discharge gas and not water may be connected to contain water supplied to the fire protection sprinkler system responding to a fire. The float-operated valve may be connected either at the gas vent or between the supply line and the fire protection sprinkler system.

A multiple zone fire protection sprinkler system inerting apparatus and method for use with a fire protection sprinkler system having a plurality of zones, according to another aspect of the invention, includes selectively connecting an inert gas source and a gas vent with a valve system to the plurality of zones of the fire protection sprinkler system. The valve system is controlled to selectively connect the inert gas source with the plurality of zones of the sprinkler system to add inert gas to the zones to increase the proportion of inert gas in the gas mixture within the plurality of zones of the sprinkler system and to selectively operate the at least one gas vent to discharge a portion of the gas mixture from the plurality of zones of the sprinkler system.

The valve system may be operated so that the gas vent discharges a portion of the gas mixture from the plurality of zones of the sprinkler system when the inert gas source is disconnected from the plurality of zones of the sprinkler system and to close the gas vent when the inert gas source is adding inert gas to the plurality of zones of the sprinkler system. A supply line or manifold may be adapted to connect the inerting system with the plurality of zones of the sprinkler system, such that the inert gas source supplies inert gas through the supply line to the plurality of zones of the sprinkler system. The gas vent may discharge at least a portion of the gas mixture from the plurality of zones of the sprinkler system through the supply line. A pressure transducer may sense pressure in the supply line and provide pressure data, wherein the gas vent is opened and closed and the inert gas source is connected and disconnected in response to the pressure data. A plurality of supply lines, or manifolds, may be provided, each connected with a plurality of zones of the fire protection sprinkler system. Each supply line may include a plurality of check-valves for maintaining isolation between the zones. Each zone may be connected with the gas vent through a check-valve in the supply line. Each zone may be connected with the inert gas source through a check-valve in the supply line.

A float-operated valve that is adapted to discharge gas and not water may be connected to the at least one supply line in order to contain water supplied to the fire protection sprinkler system responding to a fire. The float-operated valve may be connected either at the gas vent or between the valve system and the fire protection sprinkler system.

These and other objects, advantages and features of this invention will become apparent upon review of the following specification in conjunction with the drawings.

### BRIEF DESCRIPTION OF THE DRAWINGS

FIG. 1 is a schematic diagram illustrating an inerting system, according to an embodiment of the invention, connected with a fire protection sprinkler system;

FIGS. 2a-2d are a combination of pneumatic and electrical diagrams of the inerting system of FIG. 1 in various stages of operation with darkened lines illustrating operative flow paths;

FIGS. 3a-3d are pneumatic diagrams of an alternative embodiment of an inerting system in various stages of operation with darkened lines illustrating operative flow paths;

FIG. 4 is a schematic diagram of an inerting system according to another embodiment of the invention;

FIG. 5 is a timing diagram illustrating a manner of operating of the inerting system in

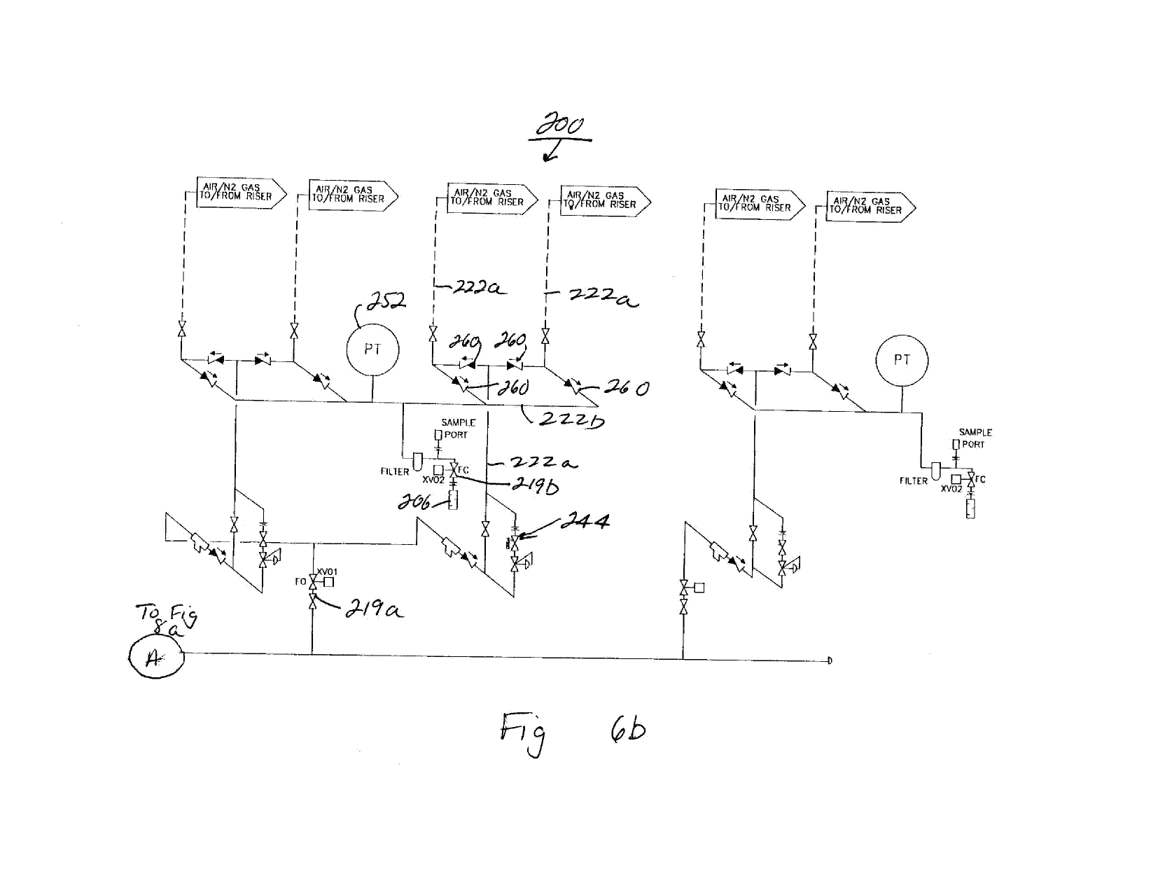

FIG. 4;

FIGS. 6a and 6b are a piping and control diagram of the inerting system in FIG. 4; and

FIG. 7 is a schematic diagram illustrating connection of an inerting system with the various zones of a multiple zone fire protection sprinkler system.

### DESCRIPTION OF THE PREFERRED EMBODIMENT

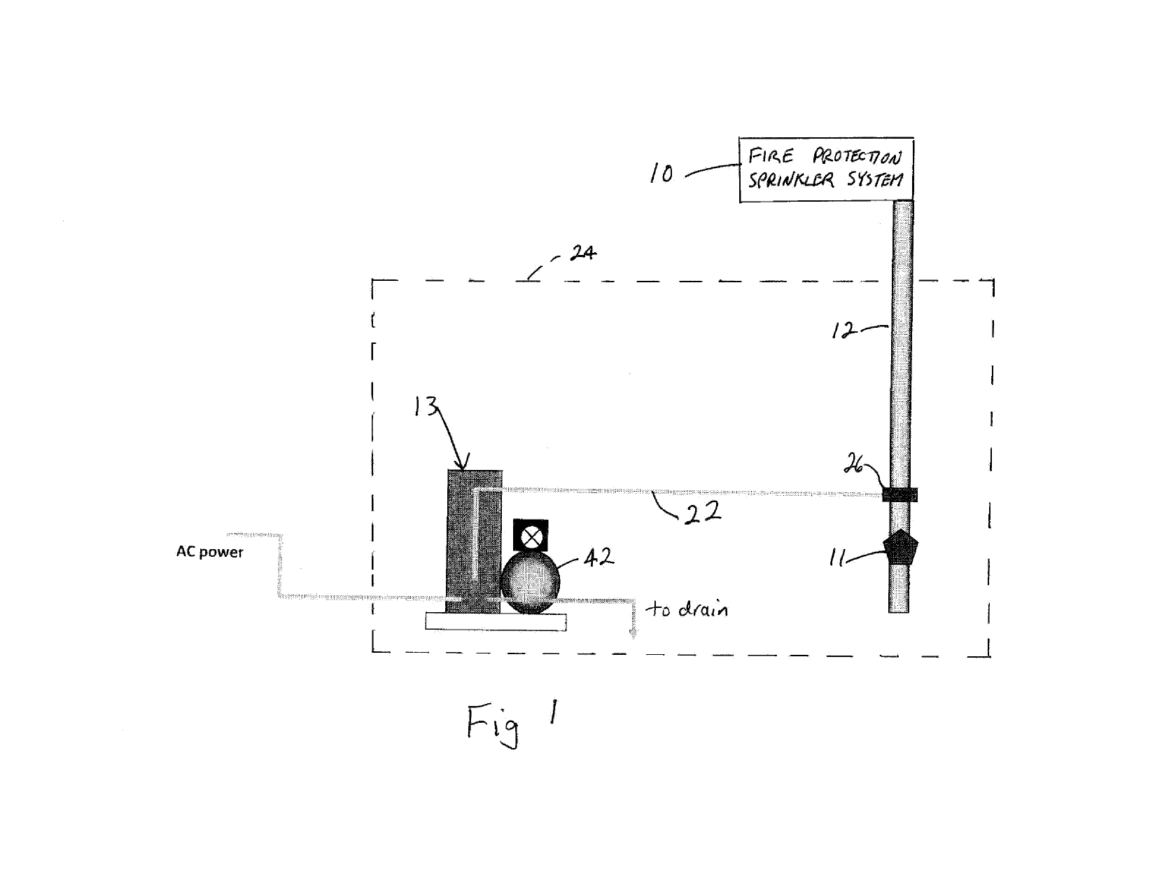

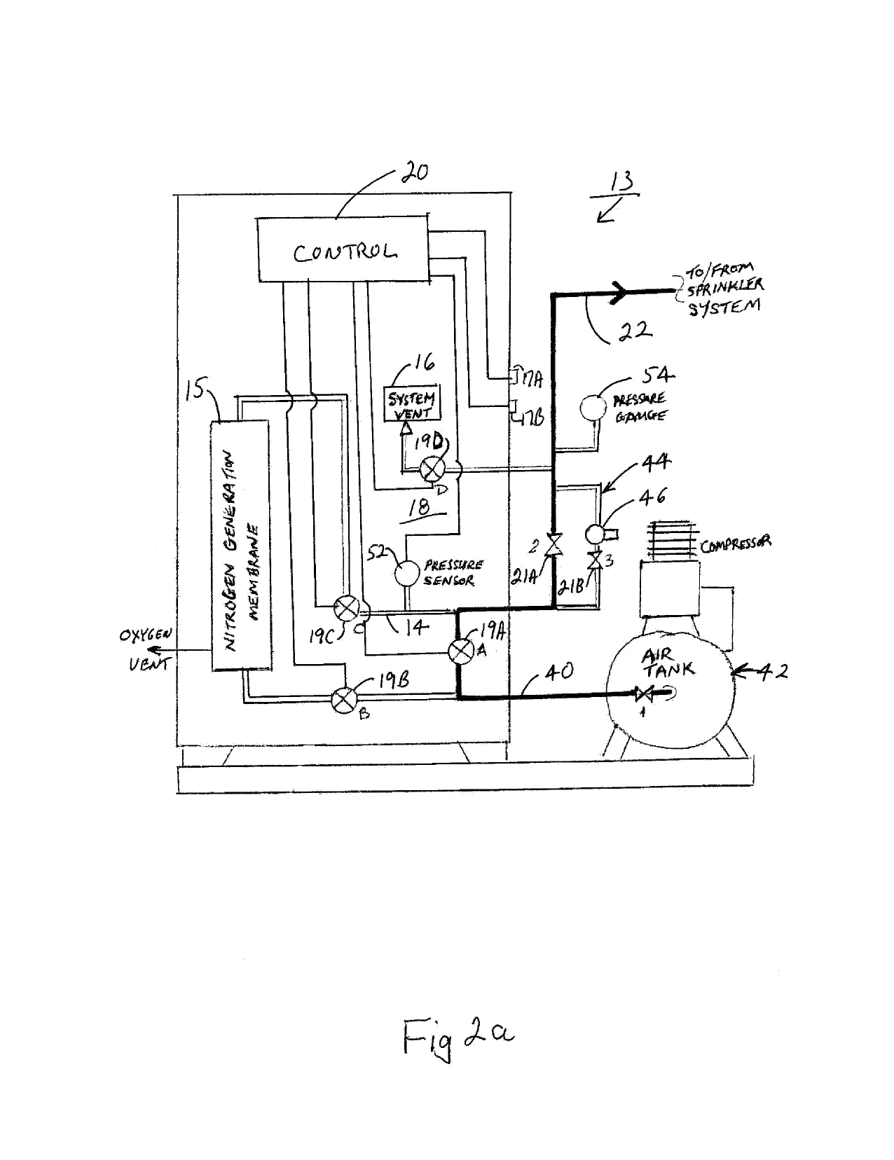

Referring now to the drawings and the illustrative embodiments depicted therein, an inerting system, or apparatus, 13 is provided for use with a dry fire protection sprinkler system 10 having a dry or pre-action valve 11 and a riser 12 downstream of valve 11 (FIG. 1). Dry fire protection sprinkler systems come in two varieties—dry pre-action fire protection sprinkler systems and dry pipe fire protection sprinkler systems. In a dry pre-action fire protection sprinkler system, an electrically or pneumatically operated valve holds water back from the piping network. A smoke or heat detector is required to operate the valve in addition to loss of gas pressure within the sprinkler system when a fire condition exists in order to flood the piping network with water. The gas followed by water is discharged when a sprinkler head is opened by heat. Maintenance air may occasionally be supplied under pressure to the piping network in the dry pre-action fire protection sprinkler system to allow maintenance of air pressure to make up for leaks in the piping network. In a dry pipe fire protection sprinkler system, a pressurized gas, such as air, in the sprinkler system piping network keeps a hinged valve closed to hold water back from the piping network. If a sprinkler head in a dry pipe fire protection sprinkler system is actuated by heat, the pressurized gas is discharged from the piping network thereby reducing gas pressure in the piping network. This allows the hinged valve to open and water to enter the piping network to be discharged through the open sprinkler head(s) to apply water to extinguish the fire. Dry fire protection sprinkler systems are typically used in areas subject to freezing temperatures as well as areas where water under pressure in the piping is undesirable, such as data centers, museums, and the like.

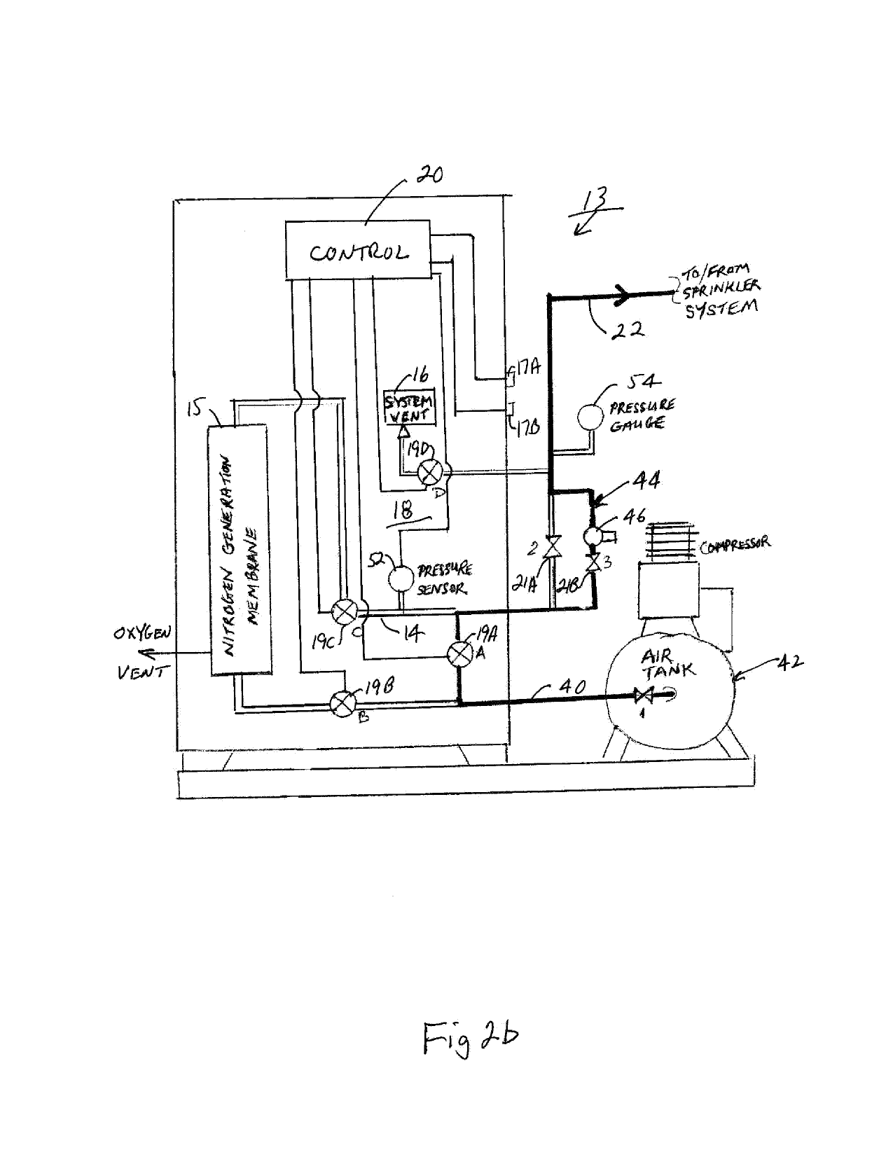

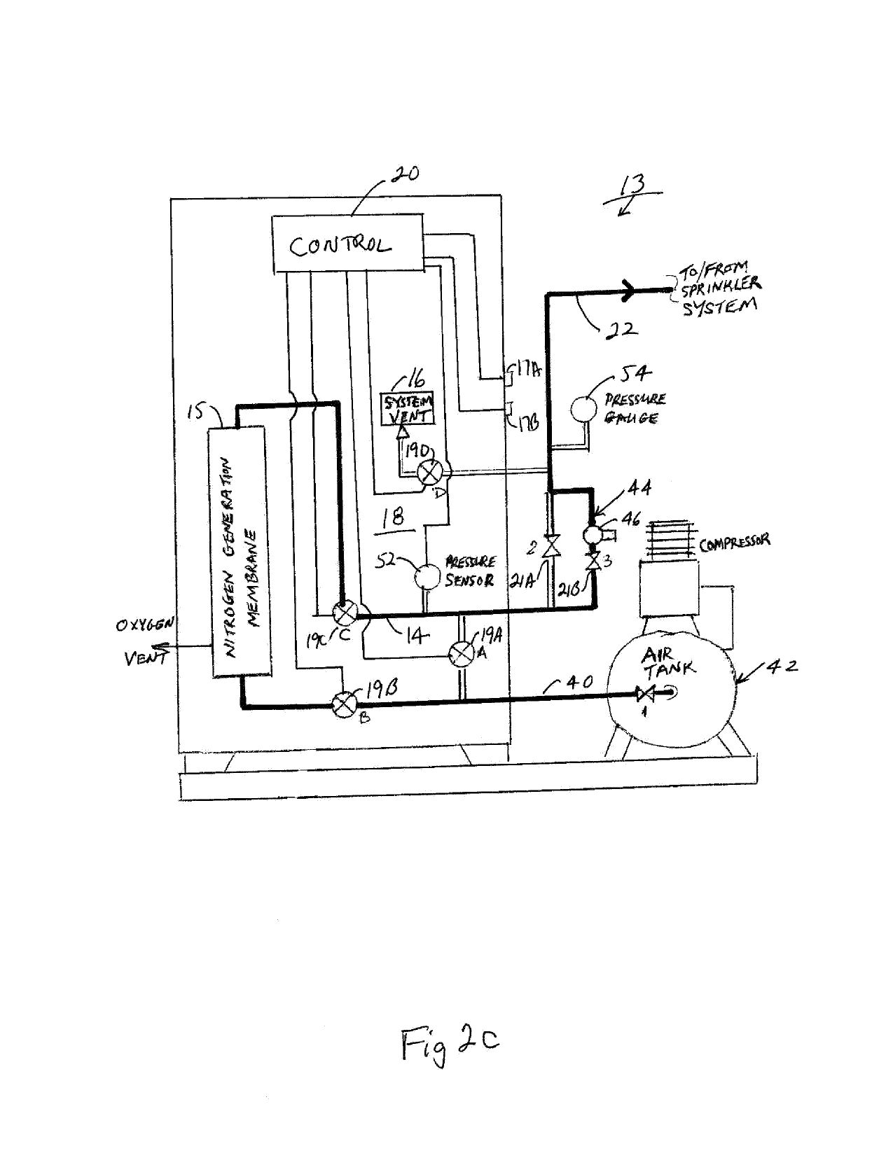

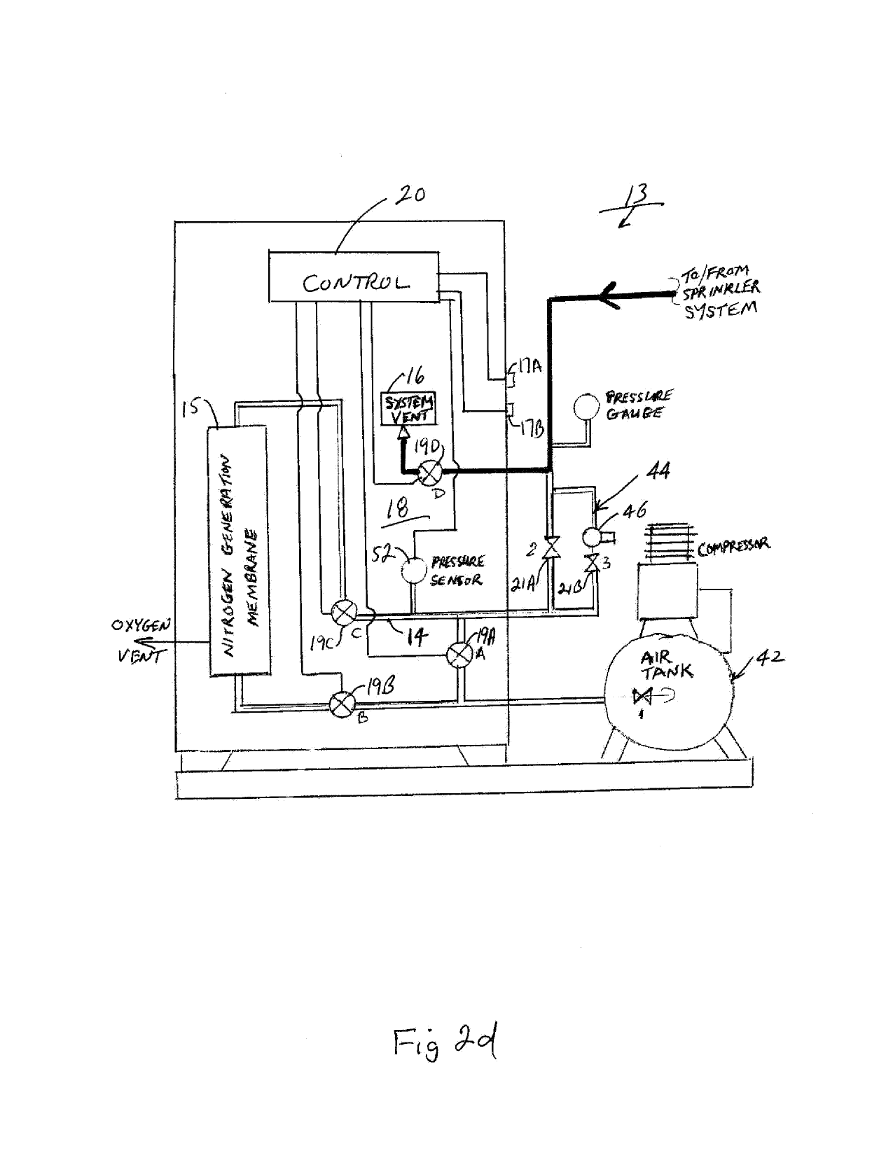

Inerting system 13 includes an inert gas source 14 and a gas vent 16 (FIGS. 2a-2d). Inerting system 13 further includes a valve system 18 and a control device 20. Valve system 18 selectively connects inert gas source 14 to sprinkler system 10 and operates gas vent 16 in the manner described in more detail below. Control device 20 controls valve system 18 to selectively connect inert gas source 14 with sprinkler system 10 to add inert gas to the sprinkler system to increase the proportion of inert gas in the air within the sprinkler system. Control device 20 also operates gas vent 16 to discharge a portion of the air from sprinkler system 10. Control device 20 may be a programmable logic controller (PLC) that is commercially available from several sources. Control device 20 receives user inputs from a user input device such as one or more switches 17A, or the like, and provides user information to a user with an output device, such as one or more indicator lights 17B. In the illustrated embodiment, inert gas source 14 is a nitrogen gas source, but other inert gases may be used. Such an inert gas source may be in the form of a nitrogen generator, a compressed nitrogen tank, an existing nitrogen line on the premises, or the like. Known types of nitrogen generators include a nitrogen membrane system including a membrane 15 supplied with compressed air from an air compressor 42. Other types include nitrogen pressure swing adsorption systems, or the like. Such nitrogen generators are commercially available from Holtec Gas Systems, Chesterfield, Mo.

Inerting system 13 includes a source 40 of compressed air from compressor 42 and a gas maintenance device 44 to supply either inert gas from inert gas source 14 or compressed air from compressed air source 40 to a supply line, or manifold, 22. Supply line 22 can be connected at a variety of locations on the sprinkler system, such as to a mechanical tee on the riser, the dry pre-action air inlet on the valve trim, or the like. Supply line 22 is supplied to fire protection sprinkler system 10 and may be connected to the sprinkler system at a mechanical tee 26 formed on riser 12. Gas vent 16 is also in fluid connection with supply line 22. In this manner, a single supply line can be connected with the fire protection sprinkler system, such as to riser 12 or other location for introducing gas into the sprinkler system. The dual use of a single line for both supplying gas and venting is achieved by controller 20 sequencing the opening and closing action of actuated valves included with the inerting system. This is possible because gas vent 16 may vent gas from sprinkler system 10 through the same supply line that supplies inert gas rather than having to be connected directly to sprinkler system 10 such as at a location remote from riser 12. However, it should be understood that it is possible to have a gas vent connect with sprinkler system 10 at a location that is remote from riser 12 particularly if it is desired to connect a gas analyzer to the sprinkler system to ensure that the sprinkler system is thoroughly inerted including portions of the sprinkler system that are remote from riser 12. Such remote gas vent may be of the type disclosed in commonly assigned U.S. patent application Ser. No. 12/606,287, filed on Oct. 27, 2009, entitled CONTROLLED DISCHARGE GAS VENT, the disclosure of which is hereby incorporated herein by reference.

In the illustrated embodiment, inerting system 13 is a packaged pre-engineered, preassembled system that can be installed in a riser room 24 without any sprinkler system accessories added downstream of riser 12. Also, a minimal amount of specialized technician labor is required to connect and operate the inerting system. Valve system 18 includes a series of valves 19A-19D that are control actuated valves as the type known in the art and operated by control device 20. While valves 19A-19D are electrically actuated valves, they could alternatively be pneumatically or hydraulically actuated, or the like. Valve system 18 may further include one or more manually operated valves 21A and 21B that may, alternatively, be control actuated valves. Manually operated valves are used in the illustrated embodiment because they are included in an off-the-shelf gas maintenance device 44 that is approved and specified by the National Fire Protection Association Code (NFPA13), Underwriting Laboratory (UL) and FM Global and, therefore, allows inerting system 13 to be used without further certification.

In operation, with control actuated valve 19A and manual valve 21A open and the rest of the valves closed, compressed air is supplied to the fire protection sprinkler system from compressor 42 at compressor output pressure in order to pressurize the sprinkler system quickly, such as within 30 minutes, or the like, as seen in FIG. 2a. After pressurization, manual valve 21A is closed and valve 21B is opened in order to insert regulator 46 of gas maintenance device 44 into the pneumatic circuit, as seen in FIG. 2b, to control the normal operating pressure of the sprinkler system.

By closing control actuated valve 19A and opening control actuated valves 19B and 19C, the compressed air is routed through air separation membrane 15 to produce an inert gas, such as nitrogen, at source 14 and to supply the inert gas to the sprinkler system through gas maintenance device 44, as seen in FIG. 2c. Gas vent control actuated valve 19D remains closed at this time so there is no venting of the sprinkler system.

When control device 20 determines via a pressure sensor 52 that the system pressure has reached a high set point, such as 60 psig, control device 20 closes control actuated valves 19B and 19C and opens control actuated valve 19D. This starts venting of sprinkler system 10 through gas vent 16. Gas vent 16 includes an internal orifice (not shown) that controls the rate of gas discharge. In the illustrated embodiment, the depressurization during the inerting cycle of the sprinkler system is intended to take approximately five to ten times as long as it takes to pressurize the sprinkler system with inert gas. The falling pressure in a sprinkler system results from the deliberate partial venting of the air having higher oxygen content from the sprinkler system. It is subsequently replaced with high nitrogen content gas. When the pressure in the sprinkler system decreases to a preset level sensed by pressure sensor 52, such as 30 psig, control actuated valve 19D closes and control actuated valves 19B and 19C open. Nitrogen now flows into the sprinkler system through gas maintenance device 44 to replace the air mixture that was previously vented.

This repeating cycle of partial venting and re-supply of inert gas is repeated in the illustrated embodiment until the nitrogen level in the sprinkler system is at a desired level, all the while the sprinkler system remaining in service protecting the facility in which it is located. This may be after a preset number of cycles or time or according to nitrogen/oxygen percentages as measured by a gas analyzer (not shown). By way of example, the complete inerting process in the illustrated embodiment may take place within approximately 60 hours to 150 hours. Once inerting of the sprinkler system is complete, gas vent 16 will remain closed and inert gas source 14 will be left in communication with the sprinkler system in a pressure maintenance mode in order to replace any loss of nitrogen, such as through leaks in the sprinkler system, with nitrogen rich gas.

In the illustrated embodiment, when control actuated valve 19D is opened, valves 19B and 19C are closed. Thus, control device 20 causes valve system 18 to operate gas vent 16 to discharge a portion of the air from the sprinkler system when inert gas source 14 is disconnected from the sprinkler system. In this manner, inerting system 13 is capable of obtaining a certain level of inert gas in the sprinkler system with a smaller inert gas source 14 than prior systems which continue to supply inert gas to the sprinkler system without regard to whether air is being discharged from the sprinkler system or not. Also, as previously set forth in certain embodiments, the gas vent may discharge a portion of the air from the sprinkler system through the same supply line, or manifold, as used by the inert gas source to supply inert gas to the sprinkler system allowing inerting to take place entirely within the riser room and within the confines of the inerting apparatus package.

In the illustrated embodiment, gas vent 16 is configured to discharge gas and not water from the sprinkler system. Such float valves are commercially available, such as from APCO Willamette Corporation. In other embodiments, the float valve is located where supply line 22 connects with the sprinkler system, as will be explained in more detail below. Also, gas vent 16 may optionally include a back-pressure regulator downstream of the gas vent. Such back-pressure regulator allows the gas vent to discharge gas above a particular pressure level and to stop discharging when the pressure has dropped below a lower pressure as disclosed in U.S. patent application Ser. No. 12/606,287, filed on Oct. 27, 2009, entitled CONTROLLED DISCHARGE GAS VENT. Also, while control actuated valve 19D is shown positioned between gas vent 16 and supply line 22, the skilled artisan would recognize that the control actuated valve could also be located at the outlet to the gas vent in order to selectively close the gas vent. Also, a filter may be provided between the control actuated valve and the gas vent in order to keep debris from clogging the small orifice in the gas vent.

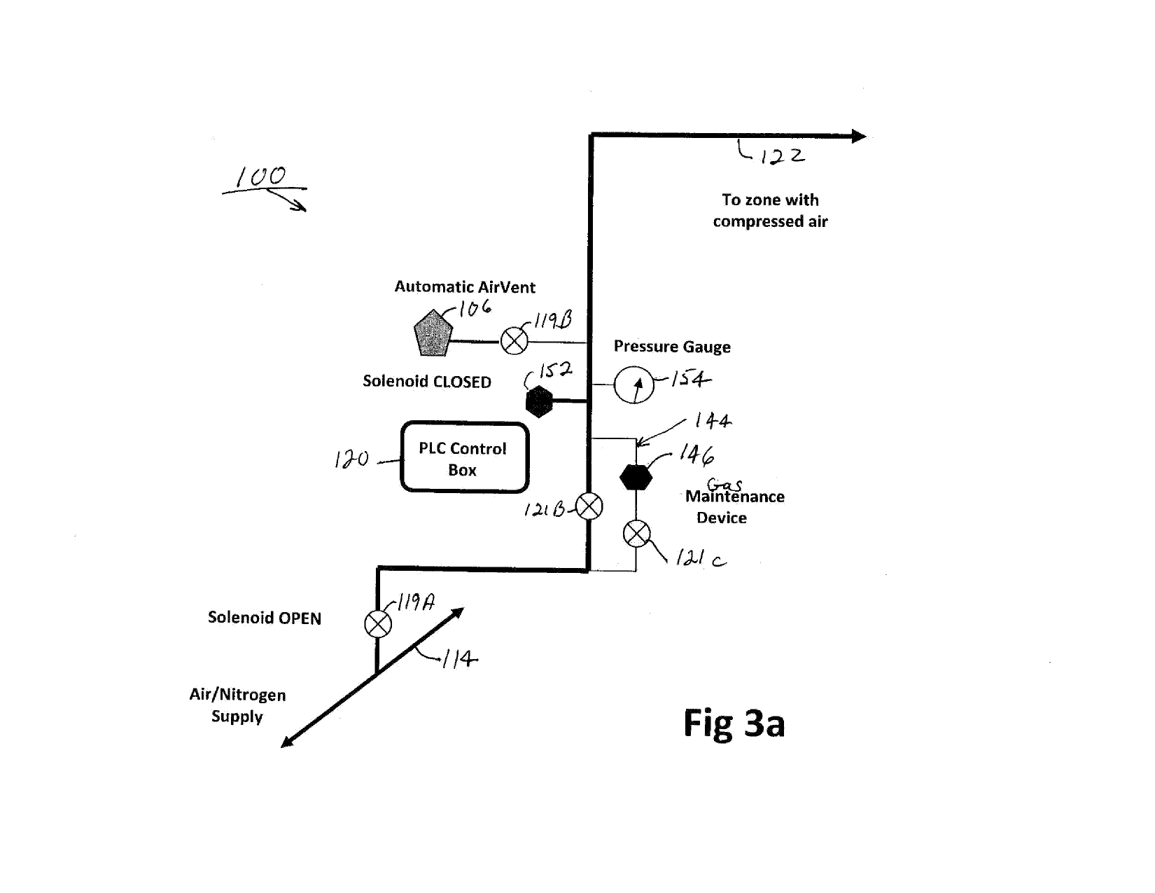

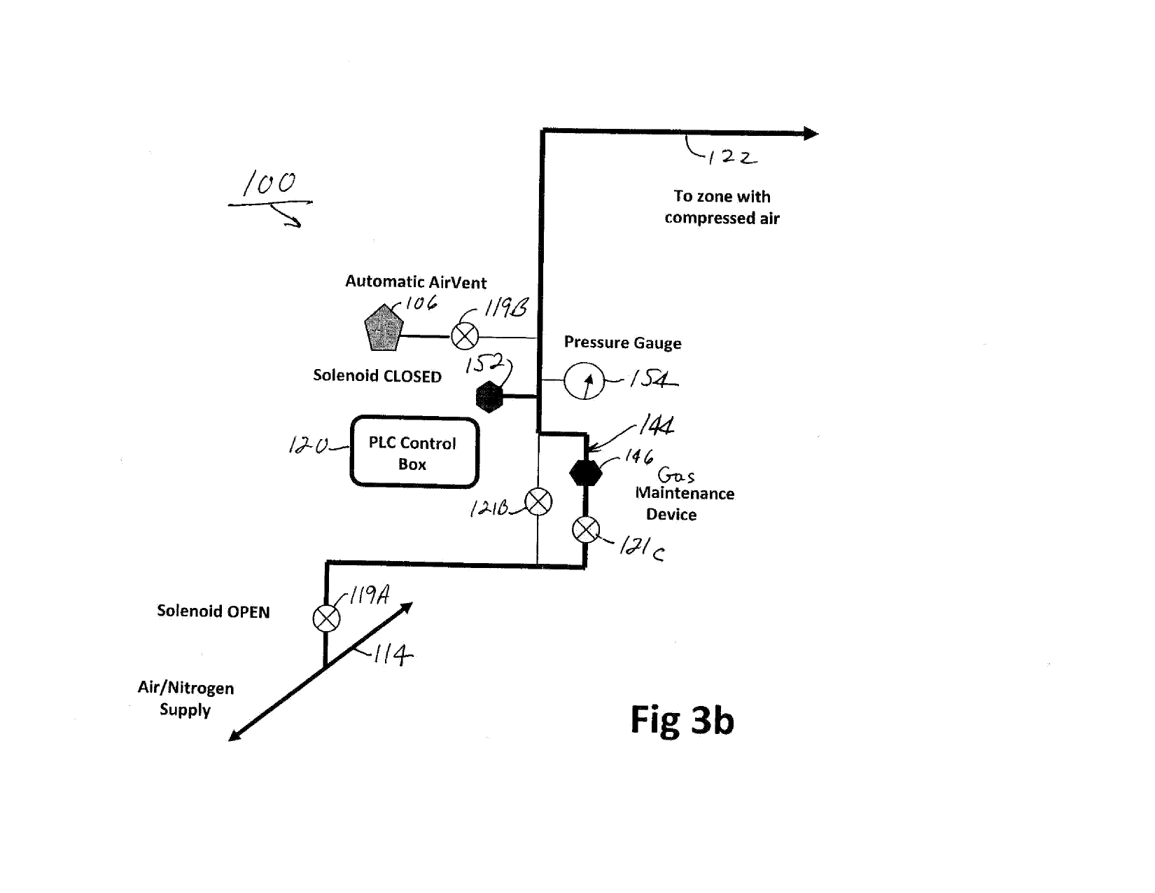

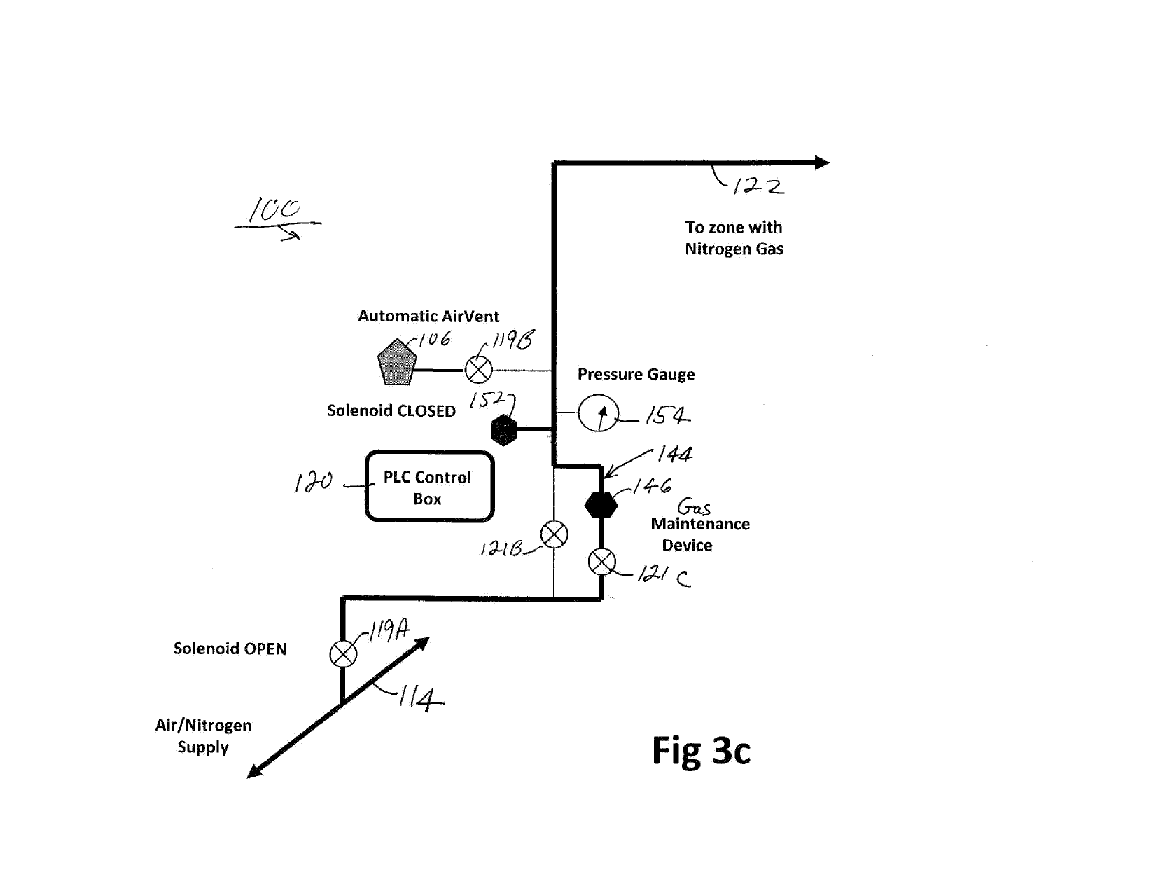

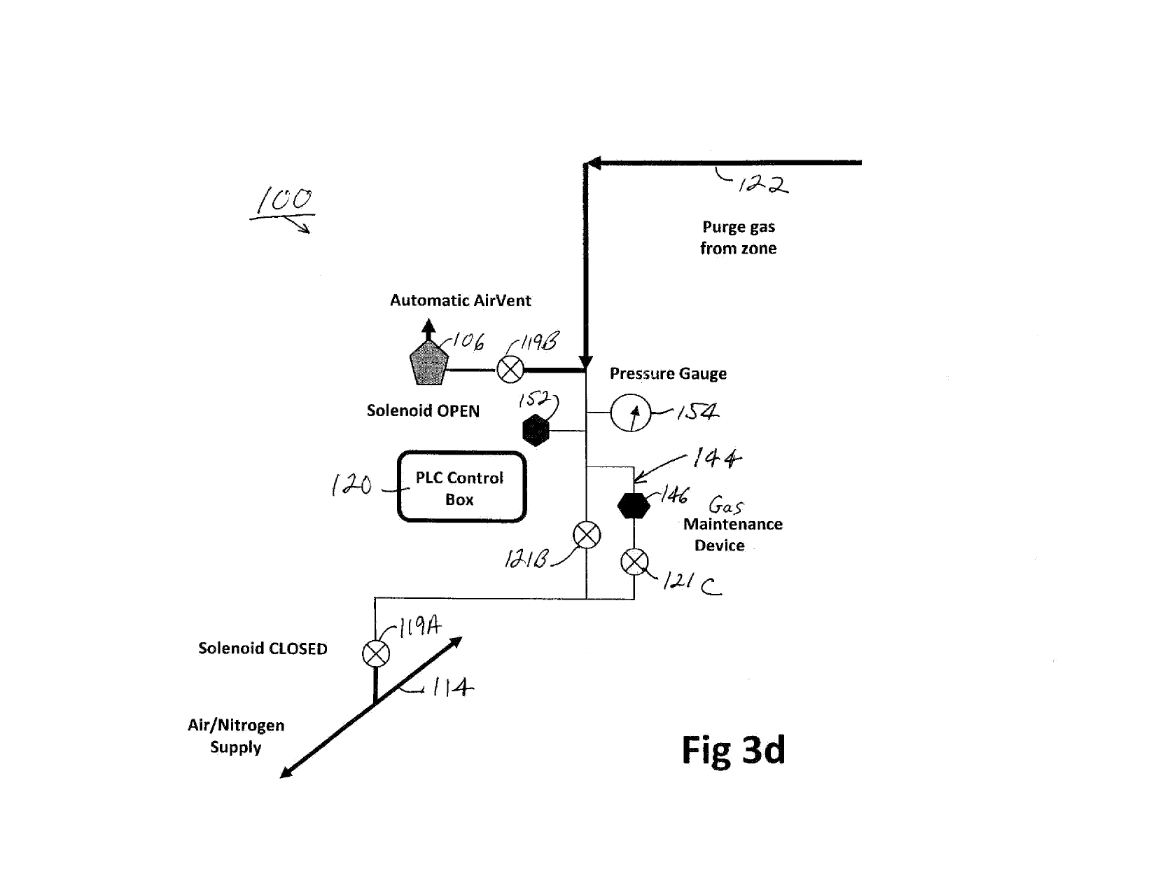

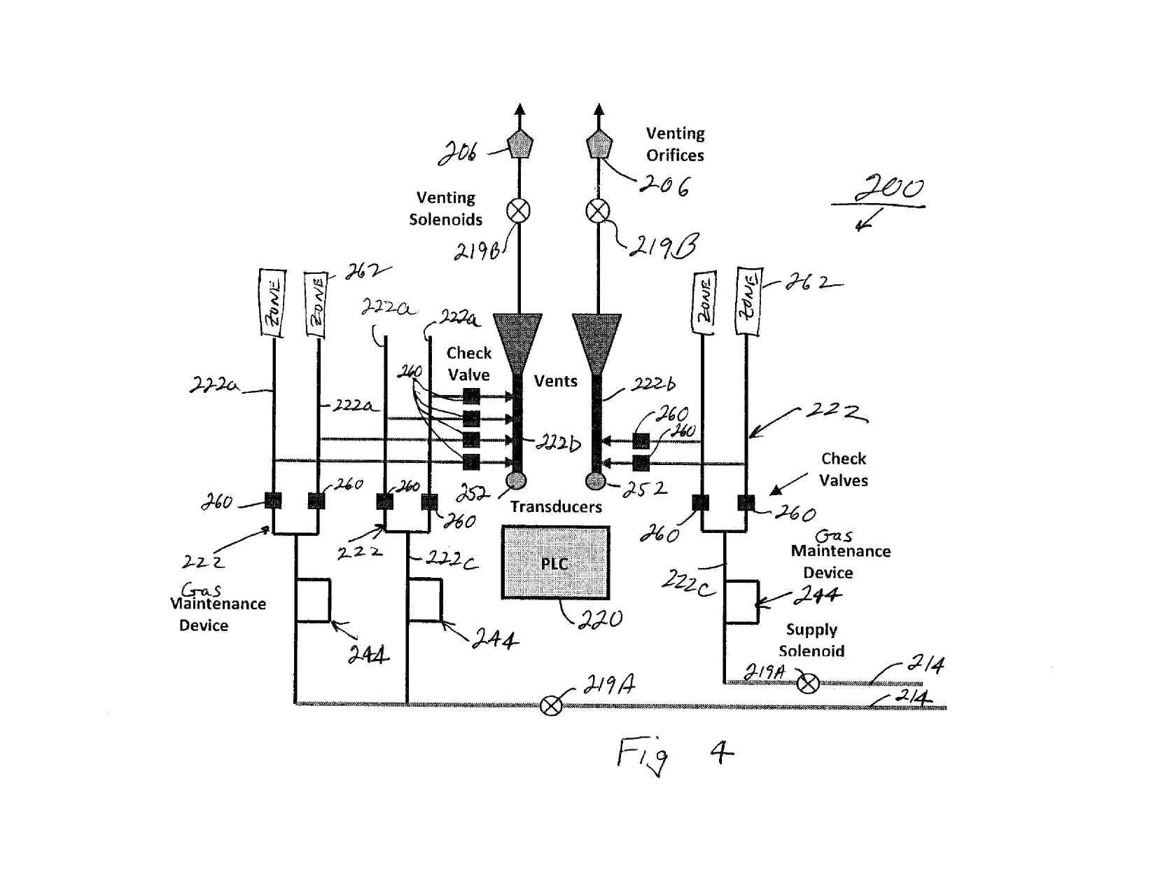

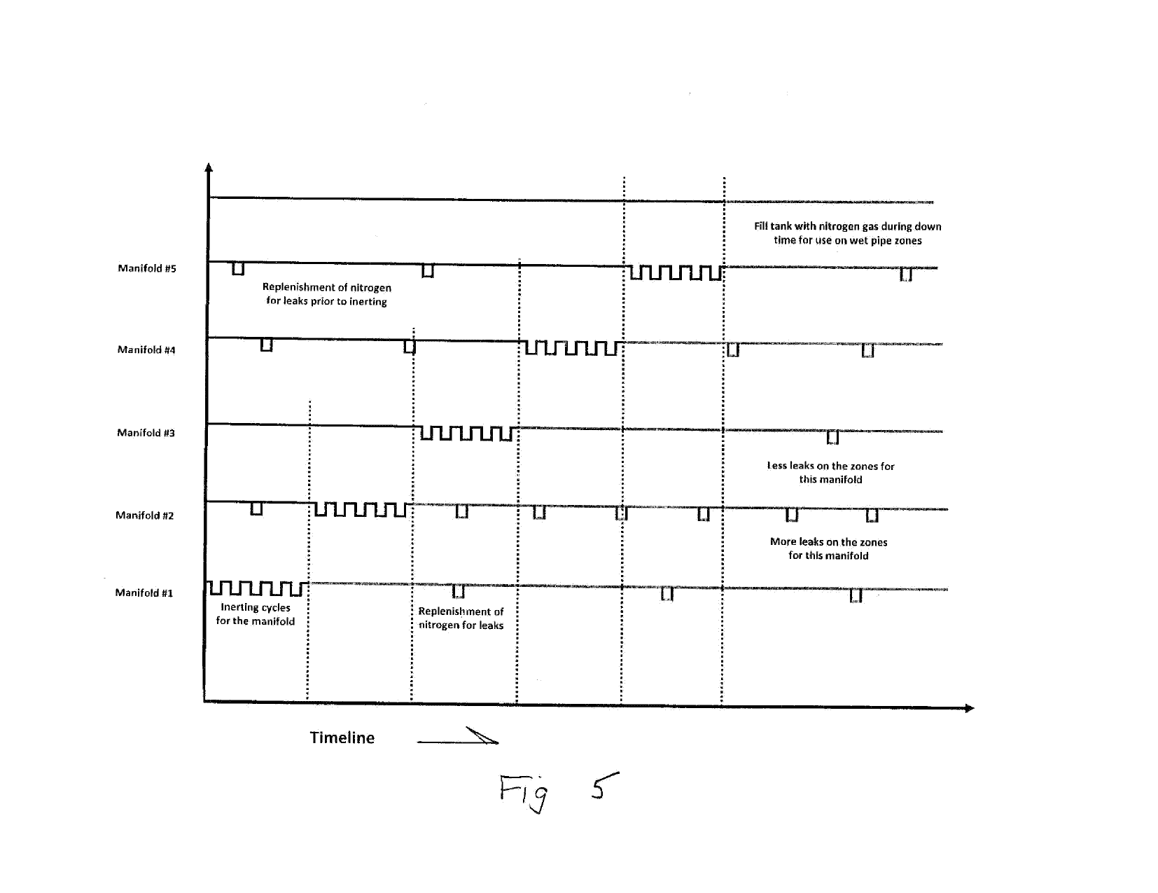

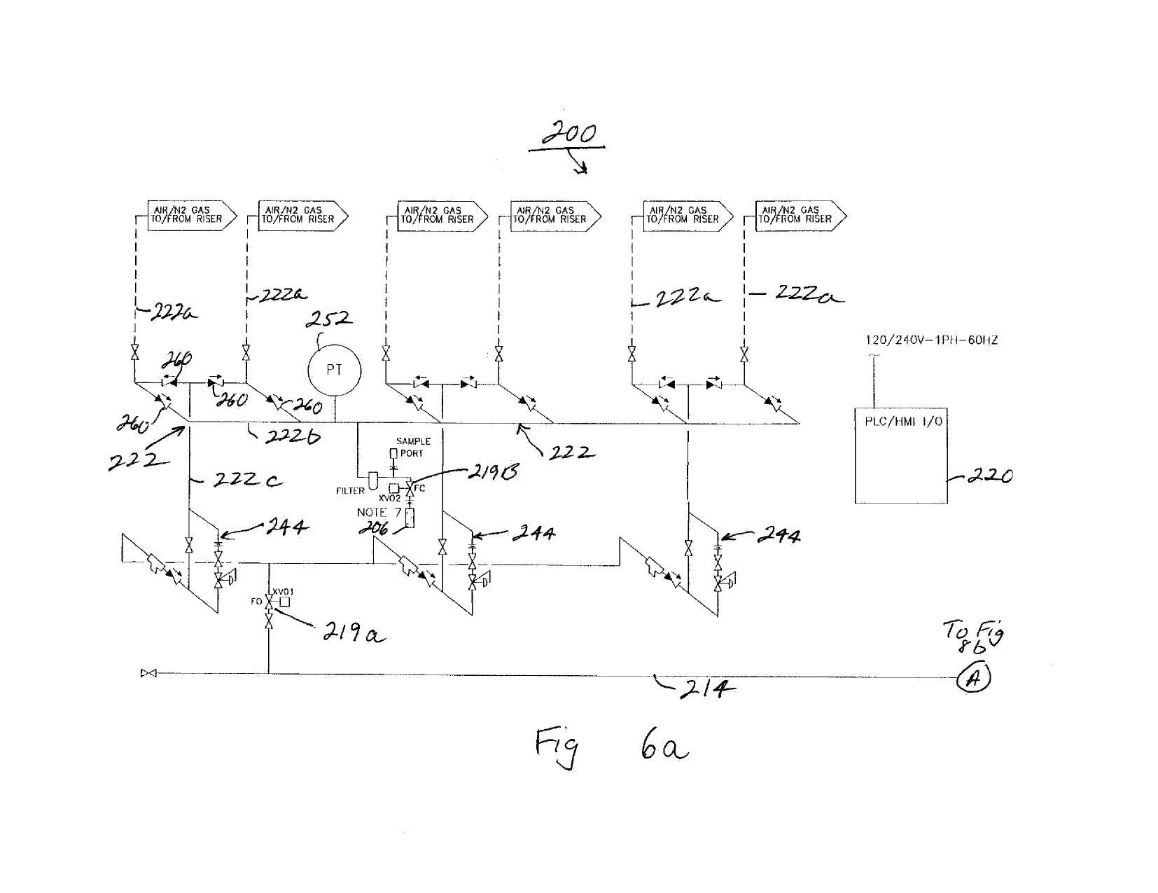

In an alternative embodiment, an inerting system 113 may be provided to separately inert each zone of a multiple zone fire protection sprinkler system (FIGS. 3a-3d). Inerting system 113 includes a plurality of inerting modules 100, each of which is supplied with a common inert gas source, which is illustrated as a nitrogen gas line 114. Line 114 also supplies compressed air to rapidly fill the sprinkler system to place it rapidly into service. Each module 100 is for use inerting one zone of sprinkler system 110. Inerting system 113 includes a plurality of gas vents 116, each with one inerting module 100 for venting one of the zones of the fire protection sprinkler system and a valve system 118 that is configured to selectively connect the nitrogen gas line to each zone of the sprinkler system as well as to operate gas vents 116. Inerting system 113 further includes a control device 120 to control valve system 118 to selectively connect nitrogen gas line 114 with each of the zones of the sprinkler system to add inert gas to the zones to increase the proportion of inert gas in the air within the zones of the sprinkler system. Control device 120 also operates valve system 118 to selectively operate gas vents 116 to discharge a portion of the air from the zones of the sprinkler system.

Because each module 100 is generally the same, only one will be described. The portion of valve system 118 for each module includes manually operated valves 121A, 121B and 121C associated with gas maintenance device 144 and control actuated valves 119A, 119B and 119C operated by control device 120. Each module further includes a pressure sensor 152 for use by control device 120 in reading system pressure. With one or more compressors (not shown) started, compressed air is supplied through a compressed air/nitrogen line 114. With control actuated valve 119A open and manual valves 121A and 121B open, compressed air flows into the sprinkler system to provide a fast fill of the zones of the sprinkler system with compressed air, as seen in FIG. 3a. Once a pressure gauge 154 shows that air pressure in the sprinkler system zone has reached a particular pressure, manual valve 121B is closed and manual valve 121C opened, as seen in FIG. 3b. This causes the compressed air to flow through a pressure regulator 146 associated with air maintenance device 144 to bring that zone of the sprinkler system up to normal operating pressure, as seen in FIG. 3b.

In response to an input selection on a control panel (not shown), valve 119A remains open and nitrogen is supplied from an inert gas source through line 114 through pressure regulator 146 to the zone, as shown in FIG. 3c. The pressure of the nitrogen supplied to the zone will be limited by the set point of regulator 146. When pressure sensor 152 senses that a particular pre-set pressure level, such as 60 psig, has been reached, control device 120 closes control actuated valve 119A and opens control actuated valve 119B. This vents the oxygen and nitrogen air from the zone at a relatively slow rate determined by an orifice (not shown) in gas vent 116, as seen in FIG. 3d. At a pre-set low pressure level, such as 30 psig, detected by pressure sensor 152, control device 120 closes vent control actuated valve 119B and opens control actuated valve 119A. Nitrogen now flows into the zone to replace the oxygen/nitrogen mixture that was previously vented, in the manner shown in FIG. 3c. This process if repeated over multiple cycles of fill and vent in the manner previously described until a satisfactory level of nitrogen is present in each zone. Inerting system 113 may then enter a pressure maintenance mode in order to replace any loss of nitrogen with nitrogen rich gas. Inert gas source may be supplied from two or more nitrogen generators to inert the fire protection sprinkler system and switch to one nitrogen generator during the pressure maintenance mode. If power is lost to control device 120, control actuated valve 119C will be open which will allow air pressure to be supplied to the sprinkler system.

Each module 100 includes gas vent in the form of an air/water separator 130, a filter 136 for avoiding debris from clogging the orifice therein, and control actuated valve 119B that selectively closes and opens the discharge of the air/water separator. An optional pressure regulator 134 may be provided in the manner previously described. All modules 100 may be controlled by a common control device 120. Each supply line 122 of each module 100 is connected with a zone, such as at the riser for that zone. This allows inerting system 113 to be located in a common riser room for the zones. Also, individual zones may be taken down for maintenance and brought back on line in the manner previously described while maintaining the inert status of the remaining zones.

An alternative inerting system 200 is capable of inerting multiple zones concurrently from a common supply line or manifold (FIGS. 4-7). System 200 includes a supply line 222 that connects a source of inert gas 214 to multiple zones 262 of the fire protection sprinkler system. Supply line 222 includes multiple legs 222a, each going to one zone 262. Legs 222a, join together though isolating check-valves 260 to form a leg 222c that is supplied with inert gas via a gas maintenance device 244. Legs 222a each connect with a leg 222b through another check valve 260 to, once again, isolate the zones from each other. Leg 222b is connected with a pressure transducer 252 that supplies pressure data to a control 220 which controls the valve system. Leg 222b of supply line 222 also connects via a solenoid valve 219b with a venting orifice 206. The venting orifice is sized to provide manageable inerting cycles based on the cumulative volume of the zones connected with that venting orifice. System 200 works best if the zones connected with one venting manifold 222 and orifice 206 have approximately the same volume. For example, the 6 zones shown in FIG. 4 may have 4 zones on the left of anywhere from 56 gallons per zone to 67 gallons per zone with the two zones on the right each having 270 gallons per zone. These are examples only.

In operation, when inlet valve 219A is open, the inert gas fills the parallel zones via supply line leg 222c and the leg 222a going to each zone through the respective check-valve 260 for that zone. Once transducer 252 senses a particular pressure, such as 35 PSIG, for example, valve 219A is closed and valve 219b for the associated venting orifice 206 is opened. This allows the gas mixture in all parallel zones to vent through leg 222b that connects each zone with the venting orifice through a check-valve 260. When the pressure sensed by transducer 252 drops to a lower pressure level, such as 25 PSIG, for example, valve 219B is closed and valve 219A is opened to introduce inert gas to the parallel zones.

Besides reducing the hardware necessary to inert multiple zones and facilitating automating of the inerting process, system 200 allows those zones to be inerted from a common inert gas line, such as from a plant nitrogen line, a nitrogen generator, or the like. Reference is made to FIGS. 6a and 6b, which shows, by way of example, 12 zones of the sprinkler system being inerted from a common source 114 of inert gas. As can be seen, anywhere from 1, 2, 4 or any number of zones can be supplied with one venting orifice 206 and one pressure transducer 252. A single control 220 controls the operation of system 200. A leg 222a of a supply line 222 is all that needs to be connected with the zone.

Connection with a zone 262 is illustrated in FIG. 7. Each leg 222a from the supply line is connected with the riser of a zone 262 through a check-valve 268 to the air inlet of a dry or pre-action valve 266 of that zone. This connection utilizes a conventional connection used by an air compressor to pressurize the zone with air and maintain valve 266 closed to hold back the water. Leg 222a may also connect with the riser through a float valve 230 via a tee fitting. This allows the zone to be directly inerted in the manner previously described. However, should the fire protection sprinkler system experience a fire event resulting in valve 266 opening, the inrush of water will not be allowed to reach inerting system 200 because float valve 230 will close in response to the water.

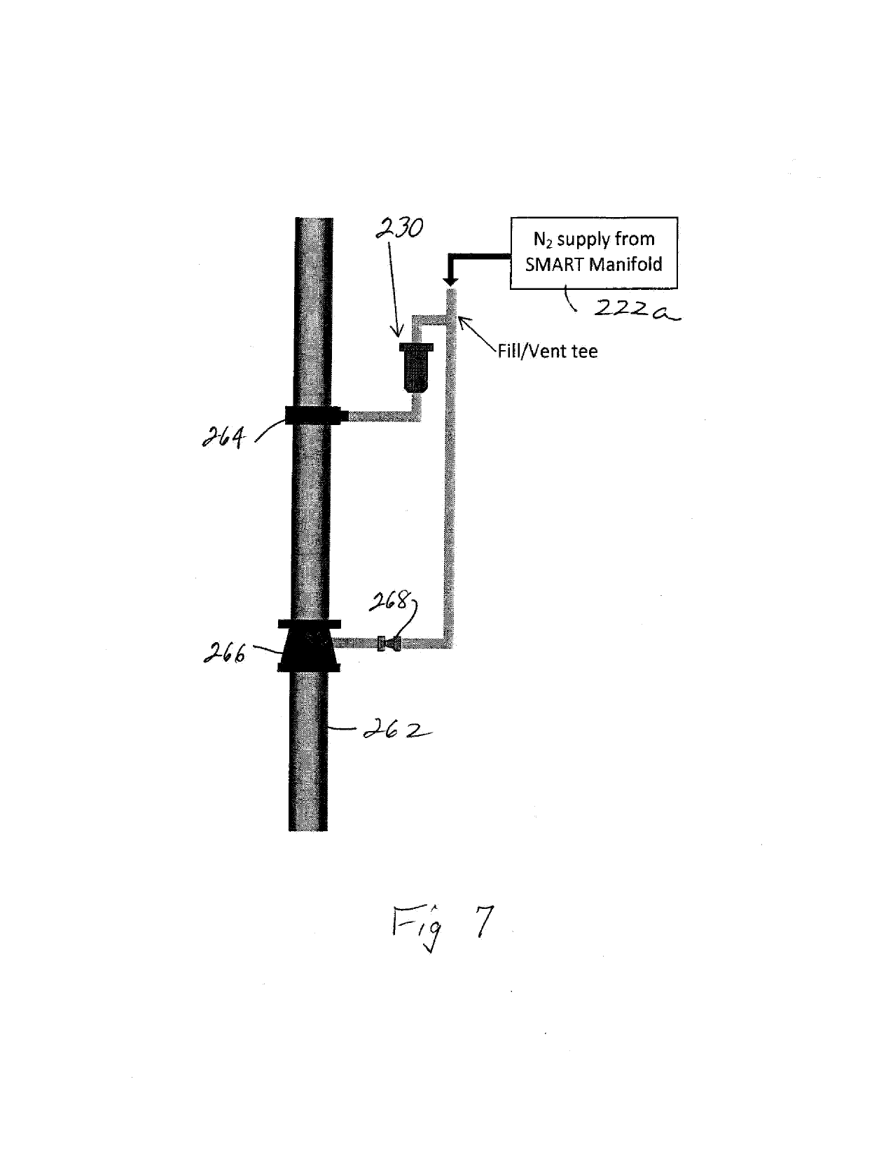

Advantageous operation of system 200 can be illustrated by reference to FIG. 5. As can be seen, the zones connected with each supply line 222, or manifold, are inerted separately from the zones connected with other supply lines 222, thereby inerting only the zone(s) connected with one manifold at a time. This can be seen as the square wave which represents the alternating connection of that manifold with inert gas source and the venting orifice. This may be repeated a number of times such as based upon a fixed number of cycles or may be based upon sensing the level of inert gas in the zones and discontinuing the inerting when a particular concentration of inert gas is reached. However, no matter how many times the inerting cycle is carried out, a certain amount of oxygen will remain in the sprinkler system because some oxygen will be carried in by the inert gas. By discontinuing the inerting cycles, the remaining oxygen in the sprinkler system can bond to the metal and corrosion will terminate.

Once the inerting cycle for a manifold is complete, control 220 begins the inerting cycle for the next manifold. Once the zones connected with a manifold are inerted, the source of inert gas is occasionally connected with that manifold in response to pressure levels in those zones dropping to a particular level as a result of leaks in the zones. This is shown as individual impulses in the chart. This can carry on until it is necessary to interrupt the integrity of the sprinkler system, such as for maintenance, or the like. However, only the zones associated with one manifold need to be taken off of inert gas, such as for maintenance, with the remaining zones fully protected from corrosion.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

1. A fire protection sprinkler system inerting apparatus, said inerting apparatus comprising:
an inert gas source;
a gas vent;
a valve system, said valve system adapted to selectively connect said inert gas source to the sprinkler system and to operate said gas vent; and
a control, said control controlling said valve system to selectively connect said inert gas source with the sprinkler system to add inert gas to the sprinkler system to increase the proportion of inert gas in the gas mixture within the sprinkler system and to operate said gas vent to discharge a portion of the gas mixture from the sprinkler system.

2. The inerting apparatus as claimed in claim 1 wherein said control causes said valve system to open said gas vent to discharge a portion of the gas mixture from the sprinkler system when the inert gas source is disconnected from the sprinkler system and to close said gas vent when the inert gas source is adding inert gas to the sprinkler system.

3. The inerting apparatus as claimed in claim 1 including a supply line that is adapted to connect the inerting system with the sprinkler system, wherein said inert gas source supplies inert gas through said supply line to the sprinkler system and said gas vent discharges a portion of the gas mixture from the sprinkler system through said supply line.

4. The inerting apparatus as claimed in claim 3 including a pressure transducer sensing pressure in said supply line and providing said control with pressure data, wherein said control opens and closes said gas vent and connects and disconnects said inert gas source in response to the pressure data.

5. The inerting apparatus as claimed in claim 3 including a discharge valve, said discharge valve adapted to discharge gas and not water, said discharge valve connected to said supply line in order to contain water supplied to the fire protection sprinkler system responding to a fire.

6. The inerting apparatus as claimed in claim 5 wherein said discharge valve is connected either at said gas vent or between said supply line and the fire protection sprinkler system.

7. A multiple zone fire protection sprinkler system inerting apparatus for use with a fire protection sprinkler system having a plurality of zones, said inerting apparatus comprising:
an inert gas source operable to supply inert gas to a plurality of zones of the fire protection sprinkler system;
a gas vent, said gas vent operable to vent the plurality of the zones of the fire protection sprinkler system;
a valve system, said valve system adapted to selectively connect said inert gas source to the plurality of zones of the sprinkler system and to operate said gas vent; and
a control, said control controlling said valve system to selectively connect said inert gas source with the plurality of zones of the sprinkler system to add inert gas to the zones to increase the proportion of inert gas in the gas mixture within the plurality of zones of the sprinkler system and to selectively operate said gas vent to discharge a portion of the gas mixture from the plurality of zones of the sprinkler system.

8. The inerting apparatus as claimed in claim 7 wherein said control causes said valve system to operate said one gas vent to discharge a portion of the gas mixture from one of the zones of the sprinkler system when the inert gas source is disconnected from that plurality of zones of the sprinkler system and to close said gas vent when the inert gas source is adding inert gas to the plurality of zones of the sprinkler system.

9. The inerting apparatus as claimed in claim 7 including a supply line, said one supply line adapted to connect said inert gas source with the plurality of zones of the sprinkler system, wherein said inert gas source supplies inert gas through said supply line to said plurality of zones of the sprinkler system.

10. The inerting apparatus as claimed in claim 9 wherein said gas vent discharges at least a portion of the gas mixture from the plurality of zones of the sprinkler system through said supply line.

11. The inerting apparatus as claimed in claim 10 including a pressure transducer sensing pressure in said supply line and providing said control with pressure data, wherein said control opens and closes said gas vent and connects and disconnects said inert gas source in response to the pressure data.

12. The inerting apparatus as claimed in claim 11 including a plurality of supply lines, each connected with a plurality of zones.

13. The inerting apparatus as claimed in claim 10 wherein said supply line includes a plurality of check-valves in order to maintain isolation between the plurality of zones.

14. The inerting apparatus as claimed in claim 13 including one of said check-valves between said inert gas source and one of said plurality of zones of said fire protection sprinkler system and one of said check-valves between one of said plurality of zones and said gas vent.

15. The inerting apparatus as claimed in claim 7 including a discharge valve, said discharge valve adapted to discharge gas and not water, said discharge valve connected to said at least one supply line in order to contain water supplied to the fire protection sprinkler system responding to a fire.

16. The inerting apparatus as claimed in claim 15 wherein said discharge valve is connected either at said at least one gas vent or between said valve system and the fire protection sprinkler system.

17. A method of inerting a fire protection sprinkler system, said method comprising:
selectively supplying inert gas to the sprinkler system to increase the proportion of inert gas in the air within the sprinkler system; and
selectively discharging a portion of the gas mixture from the sprinkler system, wherein said selectively discharging includes discharging a portion of the gas mixture from the sprinkler system when not supplying inert gas to the sprinkler system.

18. The method as claimed in claim 17 including selectively supplying inert gas from an inert gas source to add inert gas to the sprinkler system through a valve system and selectively discharging a portion of the gas mixture from the sprinkler system with a gas vent through the valve system.

19. A method of inerting a multiple zone fire protection sprinkler system, said method comprising:
selectively supplying inert gas to a plurality of zones of the sprinkler system to increase the proportion of inert gas in the gas mixture within the plurality of zones of the sprinkler system; and
selectively discharging a portion of the gas mixture from within the plurality of zones of the sprinkler system, wherein said selectively discharging includes discharging a portion of the gas mixture from the plurality of the zones of the sprinkler system when not supplying inert gas to the plurality of zones of the sprinkler system.

20. The method as claimed in claim 19 including selectively supplying inert gas from an inert gas source to add inert gas to the plurality of zones of the sprinkler system through a valve system and selectively discharging a portion of the gas mixture from the plurality of zones of the sprinkler system with a gas vent through the valve system.
